(19) United States
(12) Patent Application Publication
(10) Pub. No.: US 2026/0340838 A1
(43) Pub. Date: Oct. 29, 2026

(54) BALL SPIN AXIS DETERMINATION

(71) Applicant: TOPGOLF SWEDEN AB, Danderyd (SE)

(72) Inventors: Anton Jansson, Stockholm (SE); Joakim Lindblad, Uppsala (SE); Daniel Forsgren, Danderyd (SE)

(21) Appl. No.: 19/124,271

(22) PCT Filed: Oct. 12, 2023
(86) PCT No.: PCT/EP2023/078361

§ 371 Date: Apr. 24, 2025

(30) Foreign Application Priority Data
Oct. 28, 2022 (SE) 2230347-3

(51) Int. Cl. G06T 7/20; A63B 24/00; A63B 102/32

(52) U.S. Cl. CPC G06T 7/20; A63B 24/0021; A63B 2024/0034; A63B 2102/32; A63B 2220/16; G06T 2207/30224; G06T 2207/30241; G06T 2215/06

(57) ABSTRACT

Methods and apparatus for determining a spin axis of a ball in flight. At least a portion of an observed trajectory of the ball is obtained. The observed trajectory comprises three-dimensional locations of the ball over time. An estimated spin vector is determined at a selected point in three-dimensional space based on an acceleration of the ball computed for the selected point. The estimated spin vector is used to compute a simulated trajectory for the ball. Multiple match scores are calculated between simulated trajectories and the at least a portion of the observed trajectory. An estimated spin axis associated with a match score that surpasses a predefined match score threshold value or that has a best match score among the multiple match scores, is selected as the spin axis for the ball and is used to generate ball trajectory information to be presented on an output device.

### BACKGROUND

The present invention relates to the determination of a spin axis for an object, and more specifically, to determining a spin axis of a sports ball traveling through the air.

The spin axis of a sports ball (e.g., a golf ball, hereinafter simply referred to as a “ball”), refers to the axis around which the ball rotates during flight. The rotation around the spin axis gives rise to a lift force acting on the ball. The orientation of the spin axis affects the direction of the lift force on the ball, and therefore also the amount of curvature of a golf shot. The spin axis remains constant throughout the flight of the ball, even though the wind may “push” the ball in different directions, and is typically relative to the horizon. The spin axis can be considered analogous to the wings of an airplane, i.e., if the spin axis is parallel to the horizon, the ball will fly straight; if the spin axis is tilted to the left (i.e., the right wing being higher than the left wing), the ball will curve to the left; and if the spin axis is tilted to the right (i.e., left wing higher than the right wing), the ball will curve to the right.

It is often desirable to know the spin axis, for example, for purposes of developing clubs and other equipment, or informational purposes for the player so she can make a reasonably accurate guess about how the ball will move through the air when the ball is impacted by a particular type of equipment in a particular way.

It is well-known that for a rotationally symmetric ball in flight, three main forces act on the ball: gravity, air resistance (also referred to as “drag”), and the “lift” of the ball, as described above. These forces can be represented by vectors, and together form the total acceleration of the ball. The total acceleration can be determined from positional measurements of the ball by cameras and/or radar sensors as the ball travels through the air along its trajectory. Typically, the trajectory measurements are done in three orthogonal planes, that is, a horizontal plane (x-direction), a vertical plane (y-direction), and a depth plane (z-direction).

Using a set of simplifying assumptions and mathematical calculations, an estimate can be derived for the “lift,” which can be used to estimate a spin vector for the ball. From the estimated spin vector, a spin axis for the ball can be derived. However, the measured trajectory values are typically very noisy due to several factors, for example, inaccurate wind speed measurements, the mathematical model used to represent the camera when converting camera images to distances, the accuracy by which directions/vectors can be determined, and the hardware of the cameras (e.g., the type of image sensors, etc.), just to mention a few possible sources of errors.

### SUMMARY

In some aspects, the techniques described herein relate to a method for estimating a spin axis of a ball in flight, the method including: obtaining at least a portion of an observed trajectory of the ball, the observed trajectory including three-dimensional locations of the ball over time, as determined from individual observations of the ball by one or more sensors; determining an estimated spin vector at a selected point in three-dimensional space based on an acceleration of the ball computed for the selected point in three-dimensional space; using the estimated spin vector to compute a simulated trajectory for the ball; calculating a match score between the simulated trajectory and the at least a portion of the observed trajectory; repeating the determining, the using, and the calculating to generate multiple match scores; selecting, as a spin axis of the ball, an estimated spin axis associated with one of the multiple match scores that surpasses a predefined match score threshold value or that has a best match score among the multiple match scores; and using the selected spin axis of the ball to generate ball trajectory information to be presented on an output device.

In some embodiments, a smoothed trajectory is generated by adapting one polynomial to each dimension of the observed trajectory.

In some embodiments, the estimated spin vector is based on an acceleration determined for a point on the smoothed trajectory corresponding to the selected three-dimensional location.

In some embodiments, adapting a polynomial includes using a Random Sample Consensus (RANSAC) model, a least square model, a Huber loss function model, or a Savitzky-Golay filter on the individual observations from the sensors.

In some embodiments, adapting a one polynomial to each dimension of the observed trajectory includes: selecting four three-dimensional locations of the ball; and for each dimension, adapting one third-degree polynomial to the selected four locations of the ball.

In some embodiments, the acceleration of the ball is included of an acceleration component due to gravity, an acceleration component due to drag, and an acceleration component due to lift, and wherein the acceleration component due to lift is used to estimate the initial spin axis.

In some embodiments, calculating a match score includes comparing positional deviations between three-dimensional locations for the ball as represented by the observed trajectory and corresponding points on the simulated trajectory.

In some embodiments, calculating a match score includes comparing positional deviations between three-dimensional locations for the ball as represented by the smoothed trajectory and corresponding points on the simulated trajectory.

In some embodiments, the repeating occurs either a predetermined number of times, or until a match score is determined that is lower than the match score threshold value.

In some embodiments, selecting as a spin axis for the ball includes selecting the spin axis associated with the lowest match score among the plurality of match scores that are lower than the predefined match score threshold value.

In some embodiments, the ball is a golf ball, and the method is performed at a range.

In some embodiments, determining an estimated spin vector further includes adjusting for wind speed.

In some embodiments, the sensors include a radar, a camera, or both.

In some embodiments, selecting a three-dimensional location is done through randomization.

In some aspects, the techniques described herein relate to a computer software product arranged to, when executed, perform the method operations.

In some aspects, the techniques described herein relate to a system for estimating a spin axis of a ball in flight, the system comprising: means for obtaining at least a portion of an observed trajectory of the ball, the observed trajectory comprising three-dimensional locations of the ball over time, as determined from individual observations of the ball by one or more sensors; means for determining an estimated spin vector at a selected point in three-dimensional space based on an acceleration of the ball computed for the selected point in three-dimensional space; means for using the estimated spin vector to compute a simulated trajectory for the ball; means for calculating a match score between the simulated trajectory and the at least a portion of the observed trajectory; means for repeating the determining, the using, and the calculating to generate multiple match scores; means for selecting, as a spin axis of the ball, an estimated spin axis associated with one of the multiple match scores that surpasses a predefined match score threshold value or that has a best match score among the multiple match scores; and means for using the selected spin axis of the ball to generate ball trajectory information to be presented on an output device.

In some aspects, the techniques described herein relate to a system for estimating a spin axis of a ball, the system comprising: means for obtaining at least a portion of an observed trajectory of the ball in three-dimensional space; means for generating multiple match scores between multiple simulated trajectories and the least a portion of the observed trajectory, wherein each the multiple simulated trajectories is based on an estimated spin vector and a computed acceleration of the ball at a newly selected point in three-dimensional space; and means for presenting ball trajectory information on an output device based on an estimated spin axis associated with a selected one of the multiple match scores that surpasses a predefined match score threshold value or that has a best match score among the multiple match scores.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a schematic diagram of a spin axis determination system, in accordance with some embodiments.

FIG. 2 is a schematic diagram of a data processing system of the spin axis determination system, in accordance with some embodiments.

FIG. 3 is a flowchart illustrating the operation of the spin axis determination system when determining a spin axis for a ball in flight, in accordance with some embodiments.

FIG. 4A shows graphs of observed and smoothed acceleration values, respectively, for a ball in flight, in accordance with some embodiments.

FIG. 4B shows graphs of smoothed and estimated acceleration values, respectively, for a ball in flight, in accordance with some embodiments.

FIGS. 5A-5B schematically illustrate a user interface showing ball trajectories for an observed shot with a particular spin axis and an estimated shot under the same circumstances with a different spin axis, in accordance with some embodiments.

Like reference symbols in the various drawings indicate like elements.

### DETAILED DESCRIPTION

The various embodiments of the invention pertain to techniques for determining a spin axis for a ball in flight, based on recorded data about a trajectory traversed by a ball, such as a golf ball. In general, observations by sensors, such as cameras and/or radars, as a ball flies through the air, are processed by software to generate a trajectory for the ball. From the generated trajectory, a spin axis is determined for the ball, using a physics model that describes a relation between the acceleration of a ball and its spin axis.

The spin axis determination using the systems and techniques described in this document make it possible to reduce the noise in the observed trajectory values and can therefore provide one or more advantages, including a more robust and accurate spin axis determination compared to what is currently possible, or permit the use of different types of sensors that otherwise would have been too noisy to use in the context of spin axis calculations. Such sensors tend to be simpler and more affordable, as well as more robust, which allows for more widespread usage than what is currently possible.

Since a difference as small as 1-2 degrees in the spin axis calculation can make a big difference when determining the trajectory of a ball, the noise reduction methods described herein can have a significant impact on the accuracy of the spin axis calculation. The techniques described herein improve the functioning of a computer in terms of efficiently producing more accurate information to a player than what is currently possible as to the trajectory of the ball, both in an outdoor environment and in an indoor environment, such as a game facility, where the trajectory may need to be simulated in part due to space constraints. The spin axis information can be presented to the player in various formats. For example, some players may want to know numerical information, while others may be satisfied with knowing whether the shot is a slice, fade, draw, hook, etc. Yet other players may want to see graphical information outlining a shot on a display screen. Ultimately, the provided information can improve the skills of a player, which not only increases the enjoyment of the game, but also the safety of people sharing a common space with the player. The spin axis information can also be used to evaluate how well different types of equipment (e.g., balls, clubs, etc. made with different materials and designs) perform under different circumstances, thus ultimately contributing to developing better equipment.

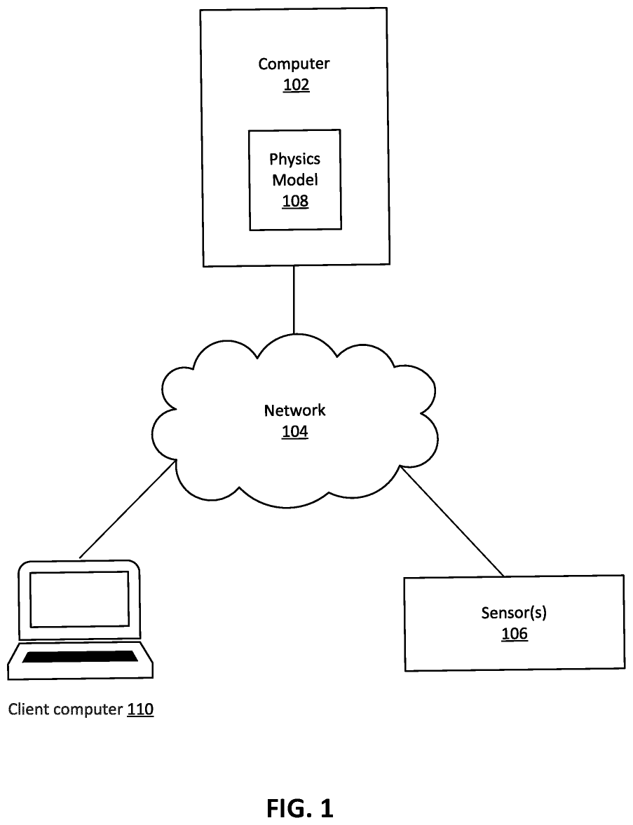

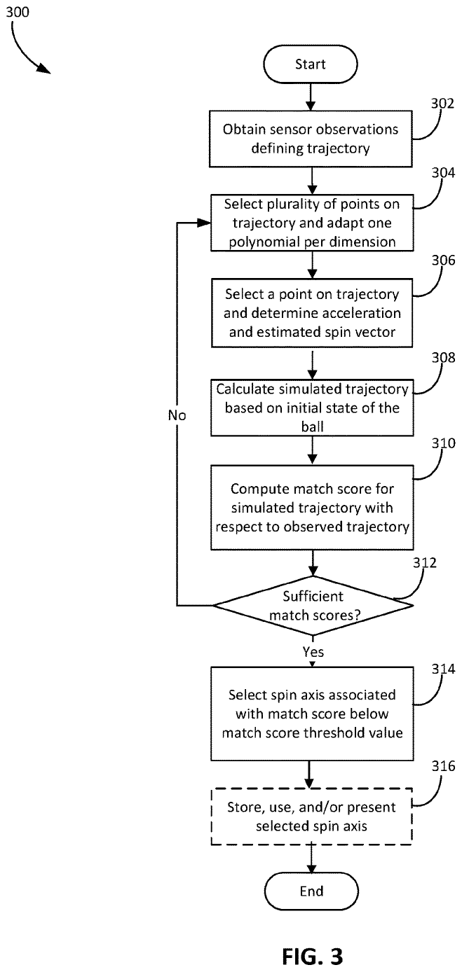

FIG. 1 shows a system, in which a computer 102 is configured to communicate over a network 104 with one or more sensors 106 to obtain observations by the sensors 106 of a ball in flight through a three-dimensional (3D) space. Examples of observations can include identification of golf balls in video sequences, and/or radar measurements of golf ball locations and speeds. In some embodiments, the observations are obtained through so-called “sensor fusion,” that is, where information from different sensors is combined to create the observations. It should be noted that in some embodiments, the computer 102 does not communicate directly with the sensors 106 but instead through an intermediary repository that stores the observations. It should also be noted that the sensors 106 do not need to be permanently connected to the network 104 but can be detachably connected, e.g., through various types of interfaces such as USB-3 and similar. The computer 102 obtains the observations by the one or more sensors 106 about the ball trajectory and applies a physics model 108 to the data to determine a spin axis, which can subsequently be used for various purposes. A more detailed description of the computer 102 in accordance with some implementations will be provided below with respect to the flowchart of FIG. 3.

The network 104 can be any combination of wired and/or wireless networks, including local networks, such as intranets, or global networks, such as the Internet. The network 104 can also include any combination of public and/or private networks.

The computer 102 can optionally communicate with a client computer 110, which can be used to display data relating to, for example, single shots, wind velocities, statistics, player data, etc., on a user interface, as described above. Various software applications can run on the client computer 110 to display the data in a preferred way to a user of the spin axis determination system. For example, the client computer 110 may contain software that presents the spin axis calculation for a recent shot to the user, along with a recommendation of one or more different types of clubs to try and what expected impact such a change of equipment would have on the ball trajectory. The computer 102 and/or the client computer 110 can be made using dedicated computer hardware or using shared computer hardware, which can be programed to produce a virtual processing environment corresponding to any suitable computer architecture.

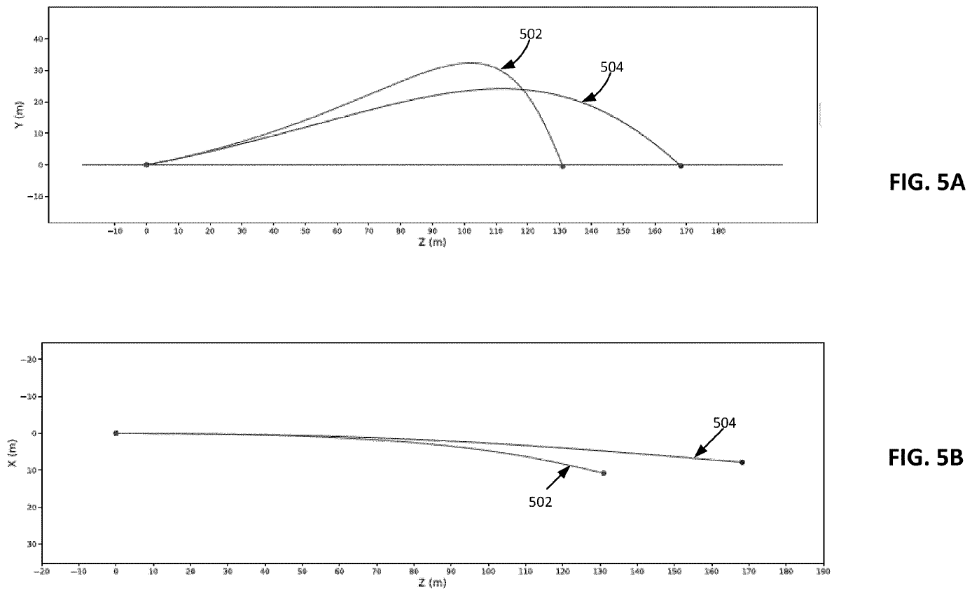

FIGS. 5A-5B show examples of graphs that can be displayed to a user on the user interface, in response to a selection being made by the user. In this case, the user has selected to show a comparison between two trajectories for a golf ball; one observed trajectory 502 for which the spin axis has been calculated, and one estimated trajectory 504 showing what the shot would have looked like if the spin axis had been slightly different, for example, as a result of using a different club, while other factors remain unchanged. By visualizing such comparisons on the user interface, the user can gain valuable information that will inform the user about how to adjust their technique or choice of clubs, for example, to become a better player.

As was mentioned above, the computer 102 obtains input data from a set of sensors 106 that capture data about a ball in flight through a three-dimensional (3D) space. The ball can be, for example, a golf ball or another type of object that is struck, kicked, or thrown (e.g., a baseball, a soccer ball, or a football/rugby ball) to travel through the air. On a more general scale, the principles of the various embodiments of the invention described herein apply to any object where the Magnus effect (i.e., the path of the spinning object is deflected in a manner that is not present when the object is not spinning, due to the difference in pressure of the fluid on opposite sides of the spinning object and the speed of rotation) forms a significant part of the combined force acting on the object.

In some implementations, the 3D space is a golf practice area, such as a golf driving range; a grass field; or another open area into which objects can be launched. For example, the 3D space can be a playing area for a sport, such as a golf course, where the ball is struck from a launch area, such as a golf tee for a particular hole on the golf course, or an intermediate landing point for a golf ball in play on the course, to a target, such as a cup at the end of the particular hole on the golf course or an intermediate landing point for a golf ball in play on the course. Other implementations are also possible, such as the launch area being one of multiple designated tee areas along a tee line where golfers can hit golf balls into an open field, or the launch area being one of multiple designated tee areas in the stands at a sports stadium where golfers can hit golf balls over and onto the playing field of the sports stadium.

Two or more sensors 106, such as cameras (e.g., stereo camera pairs), radar devices (e.g., Doppler radar devices), or combinations thereof (e.g., a camera used to sense an angle to the ball in combination with a radar used to sense a distance and/or speed of the ball), are connected to the computer 102, either directly, or through one or more computing devices, which may perform various levels of processing on the data collected by the sensors 106 prior to sending the processed data to the computer 102.

Generally, the sensors 106 are located close to the launch area for the ball. However, in some implementations, one or more of the sensors 106 can be located along one or both sides of the 3D space, and/or on the other side of the 3D space opposite the launch area. For example, at a golf tournament, the camera can be located behind the green, looking back at the golfer, assuming that shots will be hit towards the green. Thus, in various implementations, the sensors can observe and track objects that move away from a sensor, toward a sensor, and/or through the field of view of a sensor.

The sensors 106 may have different sensitivity (e.g., different image sensor resolutions), and be of varying types (e.g., radars, cameras, or combinations thereof), which may affect the quality of the data that gets transmitted to the computer 102. However, the sensitivity of the sensors 106 does not affect how the computer 102 operates, which will be described in further detail below with reference to FIG. 3. Thus, many variations of sensor setups and configurations are possible, based on the situation at hand.

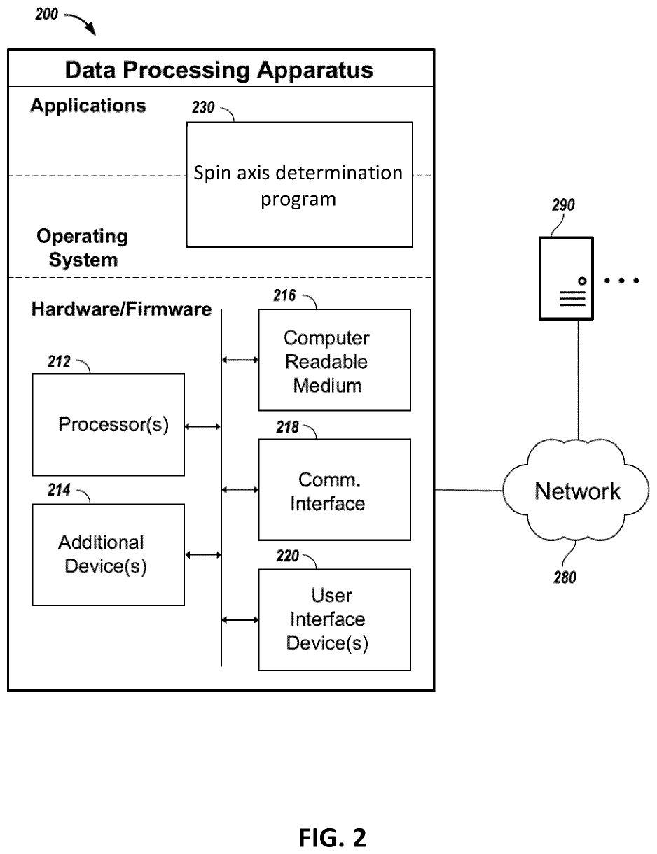

Distinct types of computers can be used in the system. The essential elements of a computer are a processor for performing instructions and one or more memory devices for storing instructions and data. As used herein, a “computer” can include a server computer, a client computer, a personal computer, embedded programmable circuitry, or a special purpose logic circuitry. FIG. 2 is a schematic diagram of a data processing system including a data processing apparatus 200, which represents an implementation of the computer 102. The data processing apparatus 200 can be connected with one or more computers 290 through a network 280.

The data processing apparatus 200 can include various software modules, which can be distributed between an applications layer and an operating system. These can include executable and/or interpretable software programs or libraries, including a program 230 which operates as a spin axis determination program for a trajectory, for example. The number of software modules used can vary from one implementation to another. Also, in some cases, the program 230 can be implemented in embedded firmware, and in other cases, the program 230 can be implemented as software modules that are distributed on one or more data processing apparatus connected by one or more computer networks or other suitable communication networks.

The data processing apparatus 200 can include hardware or firmware devices including one or more hardware processors 212, one or more additional devices 214, a non-transitory computer-readable medium 216, a communication interface 218, and one or more user interface devices 220. The processor 212 is capable of processing instructions for execution within the data processing apparatus 200, such as instructions (e.g., of the program 230) stored on the non-transitory computer-readable medium 216, which can include a storage device such as one of the additional devices 214.

In some implementations, the processor 212 is a single or multicore processor, or two or more central processing units (CPUs). The data processing apparatus 200 uses its communication interface 218 to communicate with one or more computers 290, for example, over the network 280. Thus, in various implementations, the processes described can be run in parallel, concurrently, or serially, on a single or multi-core computing machine, and/or on a computer cluster/cloud, etc.

Examples of user interface devices 220 include a display, a touchscreen display, a speaker, a microphone, a tactile feedback device, a keyboard, a mouse, and a headset or heads-up display of a virtual reality or augmented reality environment system. Moreover, the user interface device(s) need not be local device(s) 220 but can be remote from the data processing apparatus 200, e.g., user interface device(s) 290 accessible via one or more communication network(s) 280. For example, the user interface device(s) 220/290 can be a smartphone or a tablet computer of the user, e.g., for an augmented reality implementation. The data processing apparatus 200 can store instructions that implement operations as described in this document, for example, on the non-transitory computer-readable medium 216, which can include one or more additional devices 214, for example, one or more of a floppy disk device, a hard disk device, an optical disk device, a tape device, and a solid-state memory device (e.g., a RAM drive).

Moreover, the instructions that implement the operations described in this document can be downloaded to the non-transitory computer-readable medium 216 over the network 280 from one or more computers 290 (e.g., from the cloud). In some implementations, the data processing apparatus 200 is a smartphone or a tablet computer. In some implementations, the RAM drive is a volatile memory device to which the instructions are downloaded each time the computer is turned on.

FIG. 3 is a flowchart illustrating a method 300 performed by the computer 102 when determining a spin axis, in accordance with some embodiments. As can be seen in FIG. 3, the method 300 starts by obtaining 302 sensor observations that define a at least part of an observed ball trajectory. The obtaining 302 can involve retrieving the observations from another computer/system or from local memory where the observation have been actively pushed, or the obtaining 302 can involve passively receiving the observations on an ongoing basis.

Next, several points are selected 304 on the observed trajectory and one polynomial is adapted to the selected points for each dimension to create a smoothed trajectory. A point in this context refers to a position in 3D (x, y, z) at a specific time t. That is, in this embodiment, the same points are selected and fit to each dimension. The points that are used to create the smoothed trajectory are randomly selected, as the observed trajectory tends to be noisy throughout and experimentation has shown that there is little or no gain in selecting points in a more systematic fashion. However, it should be noted that the selection of points can of course be made in a systematic fashion too, such as, selecting points that are evenly spaced over a certain period of time, and so on. It should also be noted that in some embodiments, it may be possible to select different points for each dimension, in which case the polynomial adaptation would not necessarily be to the same points. However, with such an approach, there is also a risk that the selection of points is such that there may not be enough data available to describe the trajectory of the ball in 3D.

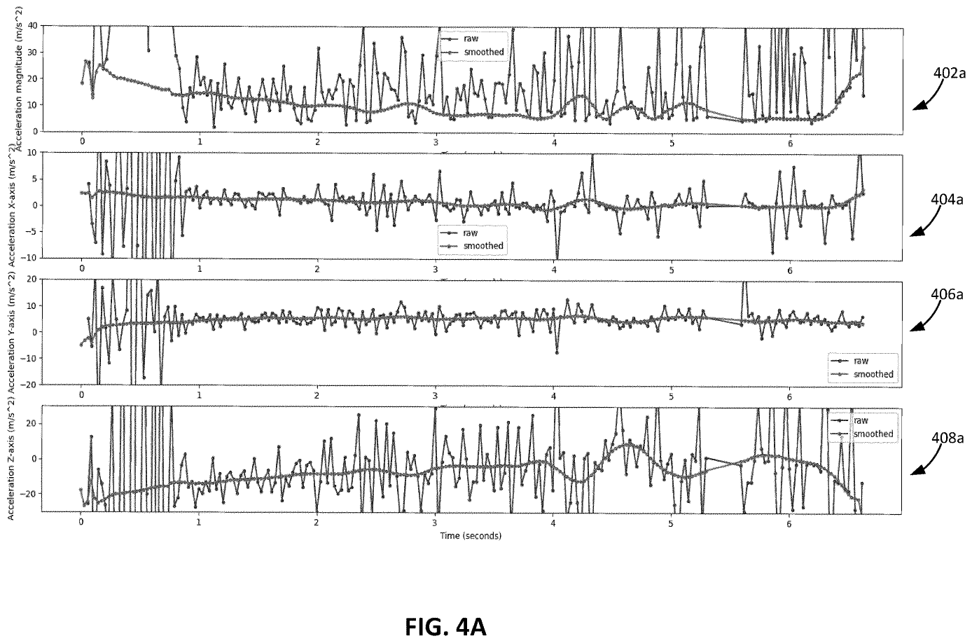

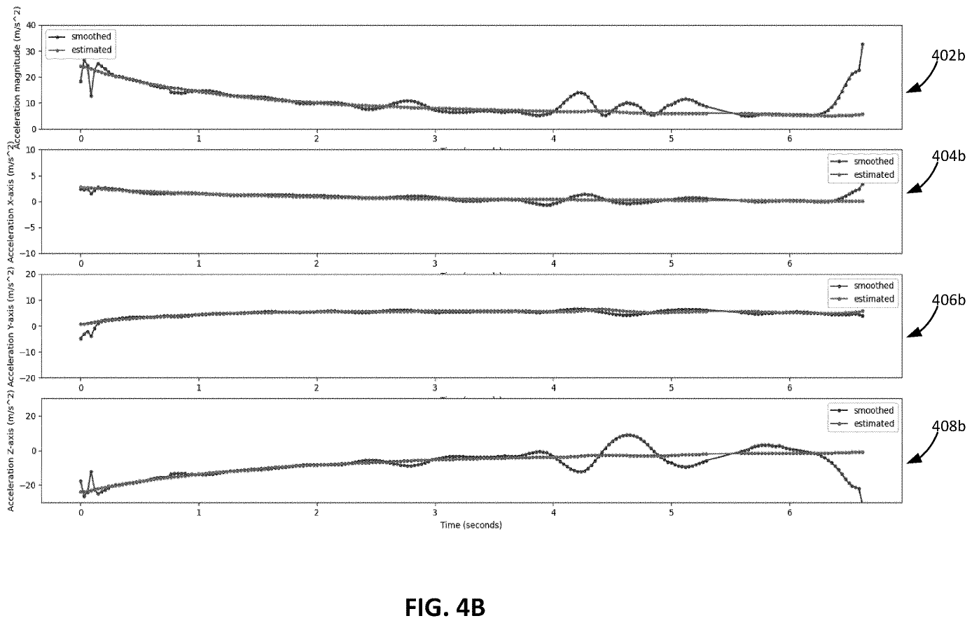

The jagged curves in FIG. 4A show acceleration data that has been calculated for a ball based on positional observations made by the sensors 106. For the sake of clarity, it should be noted again that the concept of acceleration as used in this description refers to a vector quantity, i.e., a direction and a magnitude, and just not one or the other as may often be done in colloquial language use. Further, the acceleration of the ball at any given point along its trajectory can be determined as the first derivative of the velocity of the ball, or the second derivative of the position of the ball. Thus, the graph 402a illustrated in FIG. 4A shows the observed magnitude of the acceleration (vertical axis) of the ball over time (horizontal axis). The next graph 404a shows the observed acceleration in a horizontal direction (i.e., along an x-axis) over time. The next graph 406a shows the observed acceleration in a vertical direction (i.e., along a y-axis) over time. Finally, the bottom graph 408a of FIG. 4A shows the observed acceleration along the depth direction (i.e., along a z-axis) over time. That is, together the graphs 404a-408a illustrate the ball's acceleration components along three perpendicular axes. These three components, along with the observed magnitude 402a, form the total acceleration of the ball. As can be seen by the jagged lines in FIG. 4A, this data may be very noisy, in particular in the z-direction (i.e., graph 408a), and not be of much use in itself for purposes of calculating a spin axis. For this reason, a polynomial is adapted to the points for each dimension to create a smoothed version of the data.

There are many suitable ways in which a polynomial can be adapted to the observations to create a smoothed trajectory. Some examples include a RANSAC (Random Sample Consensus) model, a Least Square model, a Huber Loss Function model, and a Savitzky-Golay filter. Exactly which model is applied depends on the particular situation at hand, but as a general rule, the choice of model should be made such that a good compromise is reached between reducing the noise in the signal, while not reducing the noise to such an extent that the signal itself gets lost or degraded. Furthermore, it is desirable to use a method that is not too complex, as there is a need to display the spin axis calculation results to a user in what is perceived as “real-time” on the client computer 110. “Real-time” in this context means that all the spin axis calculations should preferably be finished within about half a second, which may influence the choice of model. Irrespective of the model used, the end goal is to reduce the noise in the measurements such that a ball trajectory can be obtained, which allows for a meaningful comparison of an observed ball trajectory and a calculated ball trajectory, as will be described in further detail below.

Through experimentation, the inventors have determined that RANSAC generally provides good results for polynomial adaptation to the data recorded by the sensors 106. In particular, an advantage of RANSAC is that each iteration in some aspect provides an improved result, and therefore the number of iterations can be limited, while still achieving a reasonably well-adapted polynomial representing the recorded data, and being able to comply with the limits on how much time can be spent on the spin axis calculations before displaying the results to a user. Thus, polynomial adaptation using RANSAC will be used by way of example herein. However, again it should be noted that this is merely one out of many possible models for adapting a polynomial and that many alternative models may yield results that are useful for the remainder of the method described herein.

In one or more embodiments, when adapting the polynomial using RANSAC model, the trajectory is viewed as three polynomials (one polynomial per axis), each polynomial being of degree three. Thus, four observed points are selected, and a third-degree polynomial is adapted to these points for each dimension. As will be explained in further detail below, many iterations are performed, and in each of these iterations, four points will be selected. Thus, when the process is complete, a large number of points will have been selected. Each selection of four points is made randomly, so while there is a theoretical possibility that the same four points will be selected in different iterations, the odds of this happening are very unlikely if proper randomization is used, and thus not of any practical concern.

The adapted polynomials in the different dimensions can be seen in FIG. 4A as having peaks and valleys, but is significantly smoother than the raw data. In a sense, this is akin to applying a low pass filter to the data recorded by the sensors 106, to reduce noise in the measurement values.

Next, a point on the trajectory is randomly selected 306, and an estimated spin vector \hat{α} is determined for the selected point, using the following set of equations:

a=g+a_{D}+a_{L}

a−g=aₐₑᵣₒ=a_{D}+a_{L}

a_{D}=(aₐₑᵣₒ·\hat{v}ᵣₑₗ)·\hat{v}ᵣₑₗ

a_{L}=aₐₑᵣₒ−a_{D} (1)

\hat{α}=\hat{v}ᵣₑₗ×â_{L} (2)
where:
a is the combined acceleration,
g is the acceleration due to gravity,
a_{D} is the acceleration due to drag,
a_{L} is the acceleration due to lift,
\hat{v}ᵣₑₗ is the relative velocity of the ball (i.e., the velocity of the ball minus the wind velocity)

It should be noted that these equations can use either the original sensor observations or the smoothed data. However, in general, the accuracy tends to be better when the equations use the smoothed data (i.e., the adapted polynomial), as the smoothed data generally is more accurate due to less noise. Assuming that the sensor(s) measure(s) positions of the ball, the 3D-velocity for a specific point in time can be obtained using either numeric differentiation (for raw data) or analytical differentiation (for smoothed data).

As can be seen from the above set of equations, it is important to have an accurate wind estimation, such that the wind velocity can be subtracted from the velocity of the ball, when the ball's relative velocity to the air is calculated, such that this can be done as accurately as possible, and to avoid systematic errors due to wind. In some embodiments, the wind velocity is obtained from external dedicated wind measuring equipment. In some embodiments, a wind vector can be estimated by calculating a wind speed for each of several individual shots during a predefined time window, and determining a weighted average for the overall wind speed. This eliminates the uncertainty associated with calculating a wind speed based on an individual shot and thus provides a more robust value of the wind vector.

Once the estimated spin vector has been determined, a simulated trajectory is calculated 308 based on the “state” of the ball, as described by the ball's position, velocity, and estimated spin vector, and the wind vector at the time. Having this state information, together with the physics model makes it possible to apply numerical integration and to calculate the simulated trajectory. The spin vector is assumed to be constant throughout the entire shot. It should be noted that this assumption is a simplifying assumption rather than a requirement and that it is also possible to calculate a simulated trajectory with a variable spin vector, assuming a model exists for how the spin vector varies over time. Generally, there are three main such models that describe how the spin vector varies over time. The first model assumes a constant spin vector over time, as described above. The second model assumes a constant direction, and a decreasing magnitude over time, such as exponential decay, for example. The third model assumes both a changing spin axis direction and a changing magnitude over time. However, at present, most data indicates that the spin axis direction does not change over time or that the changes are negligible. As the first and second models tend to provide results with similar accuracy, and simpler calculations, they are currently favored over the third model. FIG. 4B is analogous to FIG. 4A and shows graphs 402b-408b representing the acceleration in different points along smoothed trajectory determined in FIG. 4A, and the simulated trajectory calculated based on the determined “state” of the ball. The simulated trajectories can be seen in graphs 402b-408b of FIG. 4B as the curves having the smoother shape. Thus, in a sense, the smoothed trajectories in FIG. 4B can be thought of as the “raw data” in some sense, from which the simulated trajectories are determined.

Next, a match score is calculated 310, which describes how well the simulated trajectory matches the smoothed trajectory. As noted above, in some embodiments, the matching is instead done with reference to the observations by the sensors. The match score can be calculated in several ways, for example, by comparing several discrete points on the simulated trajectory with a corresponding set of discrete points on the smoothed trajectory and calculating a least square error, or counting the number of outliers, etc. The comparison can be made, for example, in terms of ball location, velocity, or acceleration, and the result of the comparison is a match score. A lower match score generally indicates a better allover match (i.e., smaller distance) between the two curves, but of course, the match score can be defined in any way that allows a comparison to be made. Further, the reliability of the match score tends to be better if a larger portion of the full ball trajectory can be observed by the sensors 106, as there will be more comparison points available. At a minimum, four points are needed to adapt a third-degree polynomial to the observed points, and as can be realized from the above equations, the wind conditions form an important factor. For example, in an indoor environment with no wind, the portion of the trajectory can be much smaller than what is required in an outdoor environment with significant wind.

Next, the method checks 312 whether a sufficient number of match scores has been obtained. That is, the overall idea is to create several simulated trajectories and find the simulated trajectory that best matches the smoothed trajectory representing the observed ball trajectory. A single match score is not enough, so the method returns to 304 and proceeds as described above to obtain another match score. The sequence of operations described in blocks 304-312 are repeated several times. There may be different criteria for what is considered a sufficient number of match scores, i.e., when to stop repeating operations 304-312. This can be governed by the time available until a result of the calculations should be displayed to a user to achieve a “real-time” result for the user (as within a few seconds). In some embodiments, the operations in 304-312 may be repeated a predetermined number of times. In some embodiments, there may be mathematical criteria which describe when no further improvements can reasonably be expected through more iterations, for example, as a function of the “desired probability of success” which is commonly used in the context of RANSAC. Given the random nature of the selection of points in 304, there is no convergence guarantee. However, experimentation has shown that after approximately 100 iterations, a good match score can generally be found. Thus, as long as the selection of points in 304 is “sufficiently random” that will usually lead to the search space being explored, since in each iteration, the points will be selected from the same body of data describing the trajectory, and previously selected points do not influence the sampling process.

When a sufficient number of match scores has been obtained, the spin axis corresponding to the simulated trajectory having a match score below a predetermined threshold value is selected 314 as the spin axis for the shot. It is often desirable to select the lowest or “best” match score to obtain the best accuracy. However, this is not a requirement, and, in some embodiments, it may be sufficient to select a match score that is “good enough,” e.g., any match score that is lower than the predetermined threshold value. This could either happen after the iterations have been completed, or even serve as a criterion for when to stop the iterations of the operations in 304-312. In some embodiments, only the best spin axis is stored, as the operations in 304-312 are performed. That is, every time a match score is obtained that is better than the current match score, the current match score is replaced by the new and better match score. The spin axis determined in 314 can optionally be stored, used, or presented 316 in various types of applications, for example, allowing a user to benefit from the spin axis information to enhance his or her game, for example, by being provided with statistics and/or suggestions of different equipment to use, etc., which ends the method 300.

The embodiments of the present invention described herein also relates to a computer software function for determining a spin axis according to what has been described above. Such a computer software function is then arranged to, when executing, perform the above-described measuring, selecting, determining, using, computing, repeating, selecting, and using operations, which are also recited in the claims. The computer software function is arranged to execute on physical or virtual hardware of the computer 102 and/or the data processing apparatus 200, as described above.

Embodiments of the subject matter and the functional operations described in this specification can be implemented in digital electronic circuitry, or computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various computing model infrastructures, such as web services, distributed computing, and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and one or more processors of any suitable digital computer. Generally, a processor will receive instructions and data from a read-only memory (ROM) or a random-access memory (RAM), or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROM and DVDROM disks; network attached storage; and various forms of cloud storage. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode), or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be sensory feedback, e.g., visual feedback, auditory feedback, or tactile feedback; and input from the user can be received in various forms, including acoustic, speech, or tactile input.

The computing system can include clients and servers. A client and server are generally remote from each other and interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any suitable combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an internetwork (e.g., the Internet), and peer-to-peer networks (e.g., ad hoc peer-to-peer networks).

While this specification contains many implementation details, these should not be construed as limitations on the scope of the invention or of what may be claimed, but as descriptions of features specific to implementations of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Thus, unless explicitly stated otherwise, or unless the knowledge of one of ordinary skill in the art clearly indicates otherwise, any of the features of the embodiment described above can be combined with any of the other features of the embodiment described above.

Similarly, while operations are depicted in the drawings in a particular order, this should not be understood as requiring that such operations be performed in the order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments. The described program components and systems can be integrated into a single software product or packaged into multiple software products.

Thus, embodiments of the invention have been described. Other embodiments are within the scope of the following claims. For example, the description above focuses on spin axis determination in the context of the motion of a golf ball, but the systems and techniques described are also applicable to other types of objects that move through the air and are affected by wind, such as for baseball or skeet shooting, as well as non-sports applications. The spin axis determination can be further refined by improving the wind velocity estimation, for example, by considering that the wind varies with the height above ground. Further, in the above examples, it has been assumed that the acceleration of the ball is affected by gravity, lift, and drag only. However, there may be other forces at play too, for example, some kind of Coriolis effect, which can be used to further improve the physical model. The improvements that can be achieved through such changes to the physical model, though, need to be considered in view of the accuracy of the data registered by the sensors, wind measurements/estimations, etc., which may have a greater overall influence on the resulting spin axis determination.

While the above examples have referred to selecting four points and adapting a third-degree polynomial, it should be noted that the number of selected points is dependent on the number of unknowns in the model. For example, a third-degree polynomial requires the selection of four points. For higher or lower degree polynomials, the number of points may be different. It may also be the case that the observed data processed using a different technique than polynomial fitting, and then then number of points vary. Using more than four points to fit a third-degree polynomial gives rise to an overdetermined system, which might have to be solved using some kind of least squares methods, which is not desirable, as described above.

It should further be noted that the match score can be used to determine other parameters besides the spin axis. For example, equations (1) and (2) above describe how a spin vector is determined. Since the spin vector includes both a direction (i.e., spin axis) and a magnitude, the same techniques of simulating trajectories and calculating match scores can be used in various embodiments to estimate the spin rate. In some embodiments, the estimated spin rate can further be used in combination with another approach to determining spin rate, e.g., as a cross-check on the spin rate determined by a radar.

Furthermore, it should be noted that while two sensors are used in the embodiments described herein to measure the trajectory of the ball, there are other embodiments in which a single sensor (such as a Doppler radar, for example) can be used to measure both angle and distance, and thus no additional sensors are needed. Thus, many variations to the above examples lie well within the scope of the attached claims and within the capabilities of a person having ordinary skill in the art.

1. A method for estimating a spin axis of a ball in flight, the method comprising:
obtaining at least a portion of an observed trajectory of the ball, the observed trajectory comprising three-dimensional locations of the ball over time, as determined from individual observations of the ball by one or more sensors;
determining an estimated spin vector at a selected point in three-dimensional space based on an acceleration of the ball computed for the selected point in three-dimensional space;
using the estimated spin vector to compute a simulated trajectory for the ball;
calculating a match score indicating an amount of match between the simulated trajectory and the at least a portion of the observed trajectory;
repeating the determining, the using, and the calculating to generate multiple match scores;
selecting, as a spin axis of the ball, an estimated spin axis associated with one of the multiple match scores that surpasses a predefined match score threshold value or that has a best match score among the multiple match scores; and
using the selected spin axis of the ball to generate ball trajectory information to be presented on an output device.

2. The method of claim 1, further comprising:
generating a smoothed trajectory by adapting one polynomial to each dimension of the observed trajectory.

3. The method of claim 2, wherein the estimated spin vector is based on an acceleration determined for a point on the smoothed trajectory corresponding to the selected three-dimensional location.

4. The method of claim 2, wherein adapting a polynomial comprises using a Random Sample Consensus (RANSAC) model, a least square model, a Huber loss function model, or a Savitzky-Golay filter on the individual observations from the sensors.

5. The method of claim 2, wherein adapting a one polynomial to each dimension of the observed trajectory comprises:
selecting four three-dimensional locations of the ball; and
for each dimension, adapting one third-degree polynomial to the selected four locations of the ball.

6. The method of claim 1, wherein the acceleration of the ball is comprised of an acceleration component due to gravity, an acceleration component due to drag, and an acceleration component due to lift, and wherein the acceleration component due to lift is used to estimate an initial spin axis.

7. The method of claim 1, wherein calculating a match score comprises:
comparing positional deviations between three-dimensional locations for the ball as represented by the observed trajectory and corresponding points on the simulated trajectory.

8. The method of claim 2, wherein calculating a match score comprises:
comparing positional deviations between three-dimensional locations for the ball as represented by the smoothed trajectory and corresponding points on the simulated trajectory.

9. The method of claim 1, wherein the repeating occurs either a predetermined number of times, or until a match score is determined that is lower than the match score threshold value.

10. The method of claim 1, wherein selecting as a spin axis for the ball comprises:
selecting the spin axis associated with a lowest match score among the multiple match scores that are lower than the predefined match score threshold value.

11. The method of claim 1, wherein the ball is a golf ball, and the method is performed at a range.

12. The method of claim 1 wherein determining an estimated spin vector further includes adjusting for wind speed.

13. The method of claim 1, wherein the sensors include a radar, a camera, or both.

14. The method of claim 1, wherein selecting a three-dimensional location is done through randomization.

15. A non-transitory computer-readable medium encoding a computer program arranged to, when executed, perform operations comprising:
obtaining at least a portion of an observed trajectory of the ball, the observed trajectory comprising three-dimensional locations of the ball over time, as determined from individual observations of the ball by one or more sensors;
determining an estimated spin vector at a selected point in three-dimensional space based on an acceleration of the ball computed for the selected point in three-dimensional space;
using the estimated spin vector to compute a simulated trajectory for the ball;
calculating a match score indicating an amount of match between the simulated trajectory and the at least a portion of the observed trajectory;
repeating the determining, the using, and the calculating to generate multiple match scores;
selecting, as a spin axis of the ball, an estimated spin axis associated with one of the multiple match scores that surpasses a predefined match score threshold value or that has a best match score among the multiple match scores; and
using the selected spin axis of the ball to generate ball trajectory information to be presented on an output device.

16. A system for estimating a spin axis of a ball in flight, the system comprising:
a processor; and
one or more memory devices storing instructions that, when performed by the processor cause the processor to perform operations comprising:
obtaining at least a portion of an observed trajectory of the ball, the observed trajectory comprising three-dimensional locations of the ball over time, as determined from individual observations of the ball by one or more sensors;
determining an estimated spin vector at a selected point in three-dimensional space based on an acceleration of the ball computed for the selected point in three-dimensional space;
using the estimated spin vector to compute a simulated trajectory for the ball;
calculating a match score indicating an amount of match between the simulated trajectory and the at least a portion of the observed trajectory;
repeating the determining, the using, and the calculating to generate multiple match scores;
selecting, as a spin axis of the ball, an estimated spin axis associated with one of the multiple match scores that surpasses a predefined match score threshold value or that has a best match score among the multiple match scores; and
using the selected spin axis of the ball to generate ball trajectory information to be presented on an output device.

17. The system of claim 16, the operations further comprising:
generating a smoothed trajectory by adapting one polynomial to each dimension of the observed trajectory.

18. The system of claim 17, wherein calculating a match score comprises:
comparing positional deviations between three-dimensional locations for the ball as represented by the smoothed trajectory and corresponding points on the simulated trajectory.

19. The system of claim 16, wherein the acceleration of the ball is comprised of an acceleration component due to gravity, an acceleration component due to drag, and an acceleration component due to lift, and wherein the acceleration component due to lift is used to estimate an initial spin axis.

20. The non-transitory computer-readable medium of claim 15, the operations further comprising:
generating a smoothed trajectory by adapting one polynomial to each dimension of the observed trajectory.

21. The non-transitory computer-readable medium of claim 20, wherein calculating a match score comprises:
comparing positional deviations between three-dimensional locations for the ball as represented by the smoothed trajectory and corresponding points on the simulated trajectory.

22. The non-transitory computer-readable medium of claim 15, wherein the acceleration of the ball is comprised of an acceleration component due to gravity, an acceleration component due to drag, and an acceleration component due to lift, and wherein the acceleration component due to lift is used to estimate an initial spin axis.
